(19) United States
(12) Patent Application Publication
(10) Pub. No.: US 2025/0217614 A1
(43) Pub. Date: Jul. 3, 2025

(54) NON-TRANSITORY COMPUTER READABLE STORAGE MEDIUM AND GUIDELINE DISPLAY METHOD

(71) Applicant: BROTHER KOGYO KABUSHIKI KAISHA, Nagoya (JP)

(72) Inventors: Chisato INOUE, Nagoya (JP); Takumi HASHIMOTO, Nagoya (JP)

(21) Appl. No.: 18/999,237

(22) Filed: Dec. 23, 2024

(30) Foreign Application Priority Data
Dec. 27, 2023 (JP) 2023-221134

(51) Int. Cl. G06K 15/00; G06K 15/10

(52) U.S. Cl. CPC G06K 15/002; G06K 15/102

(57) ABSTRACT

A non-transitory computer readable storage medium storing a guideline display program configured to be executed by a computer in an image data generation device. The image data generation device including the computer and a display. The computer being configured to generate image data on an image. The image is formed by ejecting ink from an ejection head onto a printed medium placed on a platen. The guideline display program includes instructions which, when executed by the computer, cause the computer to execute a setting step of causing the display to display a setting screen of a guideline indicating a printable region, and a display step of causing the display to display the line and of causing the display to display the guideline on at least an inner side of the platen region.

### REFERENCE TO RELATED APPLICATIONS

This application claims priority from Japanese Patent Application No. 2023-221134 filed on Dec. 27, 2023. The entire content of the priority application is incorporated herein by reference.

### BACKGROUND ART

In the related art, there has been a printing device including a medium support unit including: a platen, which is a rectangular plate member supporting a printed medium from below; and a base positioned below the platen and supporting the platen. In such a printing device, an image is formed by ejecting ink onto the printed medium placed on the platen.

When the image to be printed is displayed by a display connected to a personal computer in a network environment in which the printing device and hardware such as the personal computer are connected to communicate with each other in a wired or wireless manner, it is considered that the region of the platen is displayed virtually. However, it is difficult for the user to recognize the printable region on the screen of the display by simply displaying the region of the platen.

An object of the present disclosure is to provide a non-transitory computer readable storage medium storing a guideline display program and a guideline display method that allow the user to easily recognize the printable region.

### SUMMARY

A non-transitory computer readable storage medium storing a guideline display program configured to be executed by a computer in an image data generation device, the image data generation device including the computer and a display,
the computer being configured to generate image data on an image, the image being formed by ejecting ink from an ejection head provided in a printing device onto a printed medium placed on a platen provided in the printing device,
the display being configured to display the image data,
the guideline display program including instructions which, when executed by the computer, cause the computer to execute:
a setting step of causing the display to display a setting screen of a guideline indicating a printable region, the guideline being allowed to have a display setting independent of a line indicating a platen region that is a region of the platen; and
a display step of causing the display to display the line and of causing the display to display the guideline on at least an inner side of the platen region, the guideline being set on the setting screen.

A guideline display method for an image data generation device configured to create image data on an image to be printed on a printed medium placed on a platen, the guideline display method including:
displaying a setting screen of a guideline indicating a printable region, the guideline being allowed to have a display setting independent of a line indicating a platen region that is a region of the platen; and
displaying the line and displaying the guideline on at least an inner side of the platen region, the guideline being set on the setting screen.

### BRIEF DESCRIPTION OF DRAWINGS

FIG. 1 is a block diagram illustrating a schematic configuration of a printing system according to an embodiment.

FIG. 2 is a plan view illustrating a configuration including an ejection head included in the printing device of FIG. 1.

FIG. 3 is an enlarged plan view of a platen and a pressing member of FIG. 2.

FIG. 4 is a diagram illustrating an example of lines and guidelines displayed by the display of FIG. 1.

FIG. 5 illustrates an example of a selection screen of platen size displayed by the display of FIG. 1.

FIG. 6 is a diagram illustrating an example of a setting screen of guidelines displayed by the display of FIG. 1.

### DESCRIPTION

Hereinafter, embodiments of the present disclosure will be described with reference to the drawings. The present disclosure described below is merely an embodiment. Accordingly, the present disclosure is not limited to the following embodiment, and can be added, deleted, or modified without departing from the scope of the present invention. In the following description, the same or corresponding elements in all the drawings are denoted by the same reference signs, and redundant description thereof is omitted.

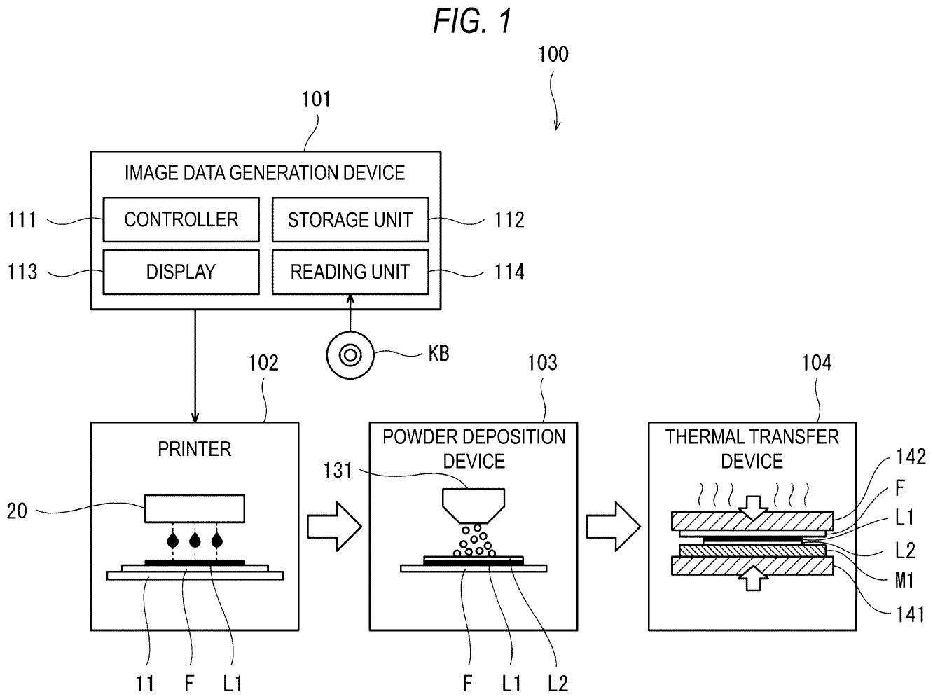

FIG. 1 is a block diagram illustrating a schematic configuration of a printing system 100 according to an embodiment. The printing system 100 is configured to transfer an image printed on a transfer film F onto the transferred medium M1 such as towel, clothing, or bag to form an image on a transferred medium M1. The transfer film F corresponds to a printed medium. The printing system 100 includes an image data generation device 101, a printing device 102, a powder deposition device 103, and a thermal transfer device 104. The guideline display program of the present disclosure includes instructions configured to cause a controller 111 described later to execute predetermined processing in the image data generation device 101. In FIG. 1, the image data generation device 101, the printing device 102, the powder deposition device 103, and the thermal transfer device 104 are exemplified as independent devices, but some or all may be integrated into a single device. For example, the printing device 102 and the powder deposition device 103 may be configured as a single device.

The image data generation device 101 includes a controller 111, a storage unit 112, a display 113, and a reading unit 114.

The controller 111 includes, for example, an integrated circuit such as a CPU and an ASIC. The controller 111 corresponds to a computer. The controller 111 is configured to create image data on an image formed by ejecting ink droplets from the ejection heads 20 described later onto the transfer film F. In this case, for example, the controller 111 is configured to create image data by executing, on any data, various processes such as resolution conversion of converting the resolution in accordance with the specifications of the printing device 102, color conversion of converting the color data in accordance with the specifications of the printing device 102, and halftone for reproducing the gradation of the image data. The image data generation device 101 includes a communication interface (not illustrated), and the controller 111 transmits the created image data as print data to the printing device 102 via the communication interface in a wired or wireless manner.

The storage unit 112 is a memory accessible from the controller 111, and includes a RAM and a ROM. The RAM temporarily is configured to store various data such as image data generated by the controller 111. The ROM is configured to store a guideline display program, a print program, predetermined data, and the like. The guideline display program may be downloaded via a predetermined communication network and stored in the storage unit 112, for example. Alternatively, for example, a guideline display program stored in a storage medium KB such as a CD-ROM or a USB flash memory may be stored in the storage unit 112 via the reading unit 114.

The display 113 is configured to display the image of the image data and guidelines GL described later, in accordance with an instruction from the controller 111. The guidelines GL will be described later in detail. The display 113 may be a touch panel integrating an input unit operated by a user and a display unit for performing a predetermined display. The reading unit 114 is configured to read the guideline display program and the like stored in the recording medium KB. The guideline display program read by the reading unit 114 is stored in the storage unit 112.

The printing device 102 includes a communication interface which is not illustrated, and is configured to receive the image data transmitted from the image data generation device 101 via the communication interface. The printing device 102 is an ink-jet printing device for ejecting ink droplets of, for example, color inks from the ejection head 11 onto the transfer film F. The ejection head 11 is a line-head or serial-head ink jet head. The printing device 102 is configured to eject ink droplets onto the transfer film F based on the image data to form an image. Thus, a layered color ink layer L1 formed from the ejected color ink is formed on the transfer film F. Details of the printing device 102 will be described later.

The transfer film F used in the printing system 100 is formed from, for example, a roll film obtained by winding a long film of several meters or more in a roll shape. The transfer film F pulled out from the roll film is continuously subjected to printing of the image by the printing device 102 and deposition of a powder by the powder deposition device 103. However, the configuration of the transfer film F is not limited thereto. For example, a cut film cut into a predetermined dimension such as A4 size or A3 size may be used as the transfer film F.

The powder deposition device 103 is configured to deposit the powder on the transfer film F that is conveyed from the printing device 102 and has the image formed thereon. For this purpose, the powder deposition device 103 includes, for example, a drum 131 for storing powder and allowing the transfer film F to pass through the stored powder. In addition to the drum 131, the powder deposition device 103 may include a rotary brush for removing excess powder from the powder deposited on the transfer film F and a heater for applying heat to the powder depositing on the transfer film F. The powder stored in the drum 131 includes an adhesive powder. The adhesive powder has a function of adhering an image formed of color ink onto the transferred medium M1.

The powder deposition device 103 is configured to deposit the adhesive powder on the transfer film F. Specifically, the transfer film F having the image formed thereon is passed through the drum 131. Thus, the adhesive powder stored in the drum 131 deposits on the color ink layer L1 of the transfer film F, and an adhesive layer L2 is formed on the color ink layer L1. When the powder deposition device 103 includes a rotary brush downstream of the drum 131, the surface of the transfer film F is brushed to have excess powder depositing on the ink removed. In addition, when the powder deposition device 103 includes a heater downstream of the drum 131 or the rotary brush, the heater can warm the transfer film F. By warming the transfer film F, the adhesive powder depositing on the ink on the transfer film F is melted and fixed on the transfer film F.

The transfer film F to which the adhesive is fixed is cooled to such an extent that the melted adhesive is re-solidified, and then sent to the thermal transfer device 104.

The thermal transfer device 104 transfers the image on the transfer film F on which the powder is deposited by the powder deposition device 103 onto the transferred medium M1. For this purpose, the thermal transfer device 104 includes, for example, a lower iron 141, an upper iron 142, and a heater mounted in the upper iron 142. The transferred medium M1 is placed on the lower iron 141. The transfer film F is placed on a desired position of the transferred medium M1. At this time, the transfer film F is placed such that the main surface on which the image is formed faces downward (that is, the main surface faces the transferred medium M1).

In this state, the upper iron 142 is lowered, and the transferred medium M1 and the transfer film F are sandwiched between the lower iron 141 and the upper iron 142. Thereafter, the heater is driven to warm the transferred medium M1 and the transfer film F. Thus, the adhesive is melted again, and the image on the transfer film F is transferred to the transferred medium M1.

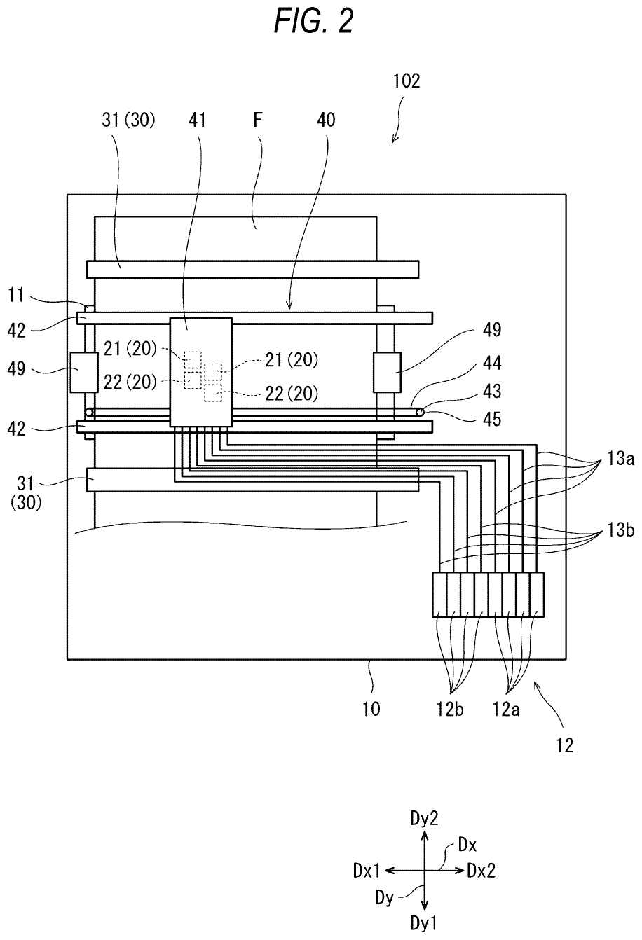

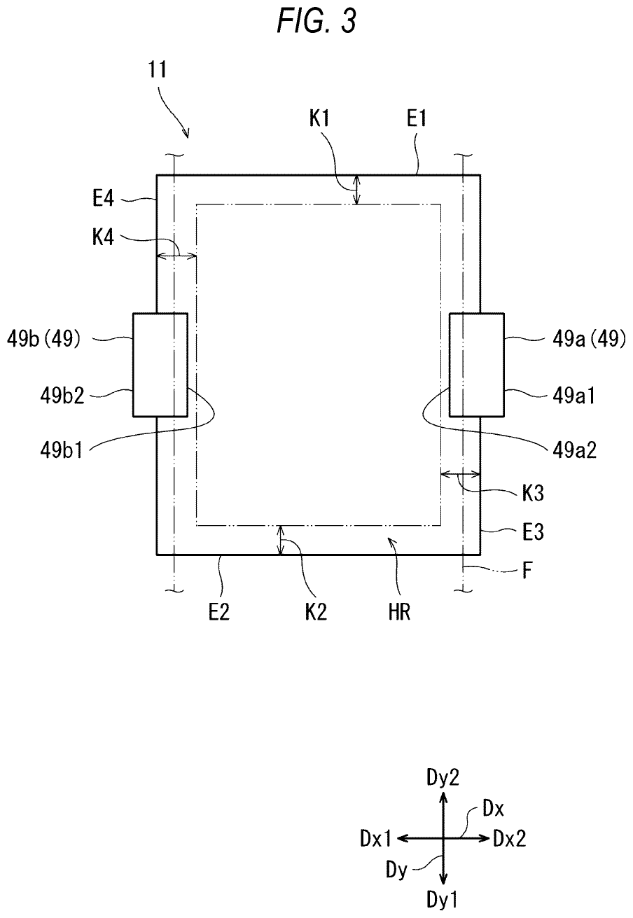

Next, FIG. 2 is a plan view illustrating a configuration including ejection heads 20 included in the printing device 102 of FIG. 1. FIG. 3 is an enlarged plan view of a platen 11 and a pressing member 49 of FIG. 2. In FIG. 2 and the like, directions orthogonal to each other are defined as a first direction Dy and a second direction Dx. In the present embodiment, for example, the first direction Dy is the conveying direction of the transfer film F, and the second direction Dx is the movement direction of the carriage 41 described later. One direction of the first direction Dy is denoted by Dy1, and the direction opposite to the direction Dy1 is denoted by Dy2. One direction of the second direction Dx is denoted by Dx1, and the direction opposite to the direction Dx1 is denoted by Dx2. However, the above directions are examples and are not limited.

As illustrated in FIG. 2, the printing device 102 includes, for example, an enclosure 10, a plurality of ejection heads 20 of a serial head system, a platen 11, a plurality of tanks 12, a conveying device 30, and a scanning device 40. The conveying device 30 corresponds to a conveying unit. The ejection heads 20, the platen 11, the tanks 12, the conveying device 30, and the scanning device 40 are accommodated in the enclosure 10.

The ejection heads 20 is configured to print the image on the transfer film F, based on the image data with a color ink or the like which is ink of basic colors. For example, the ejection heads 20 may include two first ejection heads 21 and two second ejection heads 22. The configuration of the ejection heads 20 is not limited to the configuration including the first ejection heads 21 and the two second ejection heads 22. For example, an ejection head for ejecting ink droplets of color ink may be provided alone.

The platen 11 is configured to support the transfer film F. The platen 11 defines the distance between the transfer film F arranged on the upper surface of the platen 11 and the ejection heads 20 arranged facing the transfer film F. The tanks 12 are containers for storing ink. The number of the tanks 12 may be the same as the number of types of ink. For example, the tanks 12 may include first tanks 12a for storing four types of color inks and a plurality of second tanks 12b for storing inks of special colors.

Examples of the color ink include cyan ink, yellow ink, magenta ink, and black ink. The special ink is ink of a color different from the color inks, and examples thereof include red ink, green ink, and blue ink.

The first tanks 12a is configured to store the color ink and to communicate with the first ejection heads 21 through a first flow path 13a. The color ink is supplied from the first tanks 12a to the first ejection heads 21 via the first flow path 13a. The second tanks 12b is configured to store the special ink and to communicate with the second ejection heads 22 through a second flow path 13b. The special ink is supplied from the second tanks 12b to the second ejection heads 22 via the second flow path 13b. The first flow path 13a and the second flow path 13b are formed from, for example, a rubber tube or a plastic tube.

The conveying device 30 includes, for example, two pairs of conveying rollers 31, and includes a pair of pressing members 49 and a conveying motor (not illustrated). One pair of conveying rollers 31 and the other pair of conveying rollers 31 sandwich the platen 11 therebetween in the first direction Dy. The pairs of conveying rollers 31 is arranged to sandwich the transfer film F. The conveying motor is coupled to one conveying roller of the pair of conveying rollers 31. The conveying rollers 31 are driven by the conveying motor to rotate about its axis, thereby conveying the transfer film F supported by the platen tenons 11, for example, in the direction Dy2 in the first direction Dy. The transfer film F may be conveyed in the direction Dy1 in the first direction Dy.

The scanning device 40 includes, for example, a carriage 41, a pair of guide rails 42, a scanning motor 43, an endless belt 44, and a pulley 45. The pair of guide rails 42 extend along the second direction Dx above the platen 11. The carriage 41 supports the ejection heads 20 and is supported by the guide rails 42 so as to be movable in the second direction Dx. The endless belt 44 is connected to the carriage 41 while extending in the second direction Dx and is connected to the scanning motor 43 via the pulley 45. In a case where the scanning motor 43 is driven, the endless belt 44 operates to cause the carriage 41 to reciprocate along the guide rails 42 in the second direction Dx. Thus, the ejection heads 20 supported by the carriage 41 is configured to reciprocate in the second direction Dx.

As illustrated in FIG. 3, for example, the platen 11 is formed in a rectangular shape, in a plan view. However, the shape of the platen 11 is not limited thereto, and may be various shapes. The platen 11 includes a first end E1 on one side in the first direction Dy and a second end E2 on the other side in the first direction Dy, and a third end E3 on one side in the second direction Dx and a fourth end E4 on the other side in the second direction Dx.

Among the pair of pressing members 49, one pressing member 49a is arranged on one side in the second direction Dx, and the other pressing member 49b is arranged on the other side in the second direction Dx. In FIG. 3, among the ends of the one pressing member 49a, an end 49a2 on the direction Dx1 side is positioned on the inner side of the platen 11 relative to the third end E3 of the platen 11, and an end 49a1 on the direction Dx2 side is positioned on the outer side of the platen 11 relative to the third end E3 of the platen 11. Similarly, among the ends of the other pressing member 49b, an end 49b1 on the direction Dx2 side is positioned on the inner side of the platen 11 relative to the fourth end E4 of the platen 11, and an end 49b2 on the direction Dx1 side is positioned on the outer side of the platen 11 relative to the fourth end E4 of the platen 11. The dimensions in the first direction Dy of the pressing members 49a and 49b may be the same as the dimension in the first direction Dy of the platen 11, or may be smaller than the dimension in the first direction Dy of the platen 11. In such a configuration, when the transfer film F supported by the platen 11 is conveyed by the conveying roller 31 in the direction Dy2 in the first direction Dy, the transfer film F is pressed toward the platen 11 by the pressing member 49. In a case where ink droplets are ejected by the ejection heads 20, the transfer film F is pressed toward the platen 11 by the pressing member 49. The transfer film F may not be in contact with the pressing member 49. In this case, the pressing member 49 functions as a member for preventing the transfer film F from floating.

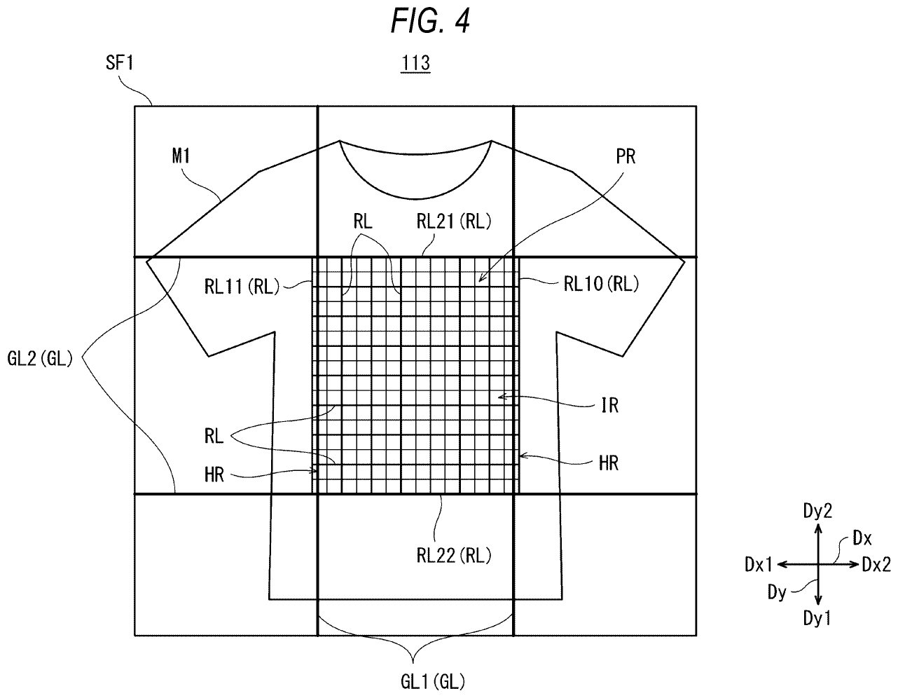

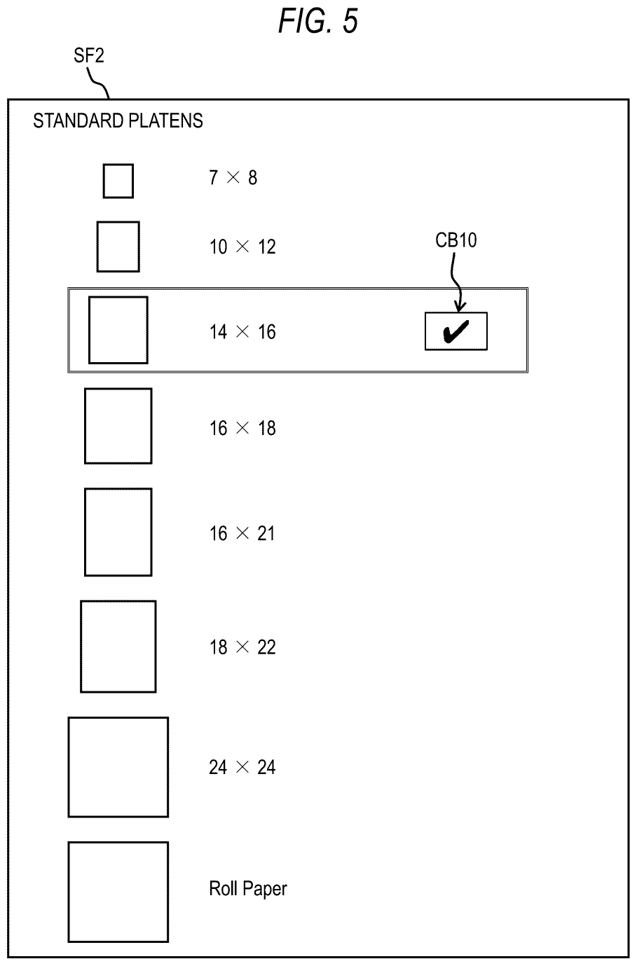

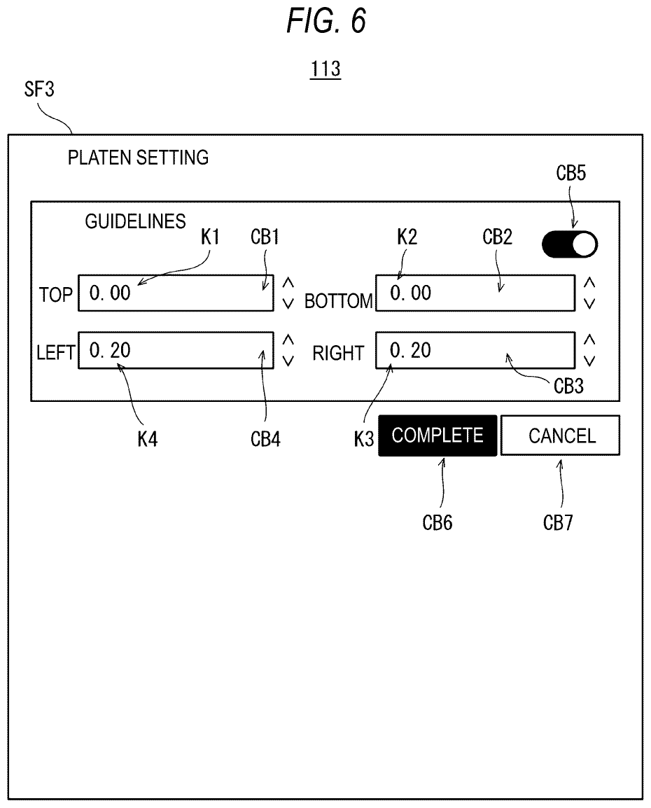

Next, FIG. 4 is a diagram illustrating an example of a screen SF1 including lines RL and guidelines GL displayed by the display 113 of FIG. 1. FIG. 5 is a diagram illustrating an example of a platen size selection screen SF2 displayed by the display 113 of FIG. 1. FIG. 6 is a diagram illustrating an example of a setting screen SF3 of the guidelines GL displayed by the display 113 of FIG. 1.

As illustrated in FIG. 4, a screen SF1 including an image of the transferred medium M1 is displayed by the display 113, according to an instruction from the controller 111 of the image data generation device 101. FIG. 4 illustrates an image of a T shirt as the transferred medium M1.

Further, according to the instruction from the controller 111, the lines RL are displayed on the screen SF1 of the display 113 at the same time as the image of the transferred medium M1 is displayed on the screen SF1 of the display 113 or before or after the transferred medium M1 is displayed on the screen SF1 of the display 113. In addition, according to the instruction from the controller 111, the guidelines GL are displayed on the screen SF1 of the display 113 at the same time as the transferred medium M1 is displayed on the screen SF1 of the display 113 or before or after the transferred medium M1 is displayed on the screen SF1 of the display 113. In the present embodiment, the information on the guidelines GL and the information on the lines RL are not included in the image data. The display of the lines RL and the display of the guidelines GL may or may not be at the same time.

The lines RL indicate the platen region PR that is the region of the platen 11. The platen region PR is a region surrounded by the outer edge of the platen 11. A plurality of lines RL are displayed on the display 113. The lines RL include a plurality of lines displayed along the first direction Dy and a plurality of lines displayed along the second direction Dx. For example, the plurality of lines RL along the first direction Dy may be arranged such that the adjacent lines RL have a constant interval (for example, 10 mm). In addition, the plurality of lines RL along the second direction Dx may be arranged such that the adjacent lines RL have a constant interval (for example, 10 mm). That is, the plurality of lines RL along the first direction Dy and the plurality of lines RL along the second direction Dx may be combined with each other and arranged in a grid-like pattern, for example.

Among the plurality of lines RL along the second direction Dx, a line RL displayed at the end on the direction Dy2 side in the first direction Dy is a line RL21, and a line RL displayed at the end on the direction Dy1 side in the first direction Dy is a line RL22. The line RL21 indicates the first end E1 of the platen 11, on the screen SF1. The line RL22 indicates the second end E2 of the platen 11, on the screen SF1. In addition, among the plurality of lines RL along the first direction Dy, a line RL displayed at the end on the direction Dx2 side in the second direction Dx is a line RL10, and a line RL displayed at the end on the direction Dx1 side in the second direction Dx is a line RL11. The line RL10 indicates the third end E3 of the platen 11, on the screen SF1. The line RL11 indicates the fourth end E4 of the platen 11, on the screen SF1. The ends E1 to E4 indicate the outer edge of the platen 11.

The platen region PR, which is the outer edge of the platen region PR, is indicated by the line RL21, the line RL22, the line RL10, and the line RL11. FIG. 4 illustrates an aspect in which the line RL21, the line RL22, the line RL10, and the other lines RL excluding the line RL11 are displayed, but is not limited thereto, and the other lines RL do not have to be displayed. In this case, only the line RL21, the line RL22, the line RL10, and the line RL11 indicating the platen region PR are displayed.

The guidelines GL are allowed to have a display setting independent of the lines RL, and indicate a printable region IR. The printable region IR is displayed in the region where the image of the transferred medium M1 is displayed. The printable region IR is a region in which the image can be printed. The printable region IR is a region surrounded by first-direction guidelines GL1 and second-direction guidelines GL2 described later as the guidelines GL. Alternatively, the printable region IR may be a region surrounded by the first-direction guidelines GL1 and the second-direction guidelines GL2 as described above but include a region not surrounded by these guidelines GL1, GL2, that is, a region HR not printed on the transfer film F, which will be described later. In other words, the printable region IR may be the same as the platen region PR, which is a region surrounded by the line RL21, the line RL22, the line RL10, and the line RL11. The guidelines GL can be set in a setting screen SF3 displayed by the display 113, which will be described later. The guidelines GL set by the user on the setting screen SF3 is displayed by the display 113 in the display step.

The controller 111 is configured to cause the display 113 to display, as the guidelines GL, any one of the first-direction guidelines GL1, the second-direction guidelines GL2, or the first-direction guidelines GL1 and the second-direction guidelines GL2. The first-direction guidelines GL1 are guidelines GL along the first direction Dy. The second-direction guidelines GL2 are guidelines GL along the second direction Dx. FIG. 4 illustrates an aspect in which both the first-direction guidelines GL1 and the second-direction guidelines GL2 are displayed. In addition, FIG. 4 illustrates an aspect in which two first-direction guidelines GL1 and two second-direction guidelines GL2 are displayed. One of the first-direction guidelines GL1 is displayed apart from the other first-direction guidelines GL1 in the second direction Dx. One of the second-direction guidelines GL2 is displayed apart from the other second-direction guidelines GL2 in the first direction Dy.

Here, both the first-direction guidelines GL1 and the second-direction guidelines GL2 are displayed at least on the inner side of the platen region PR. Thus, the printable region IR is displayed on the inner side of the platen region PR. Specifically, the first-direction guidelines GL1 and the second-direction guidelines GL2 are displayed on the inner side of the line RL21, the line RL22, the line RL10, and the line RL11, which indicate the platen region PR. In this case, one of the first-direction guidelines GL1 may be displayed overlapping with the line RL10, and the other one of the first-direction guidelines GL1 may be displayed overlapping with the line RL11. In addition, one of the second-direction guidelines GL2 may be displayed overlapping with the line RL21, and the other one of the second-direction guidelines GL2 may be displayed overlapping with the line RL22. FIG. 4 illustrates an aspect in which one of the second-direction guidelines GL2 is displayed overlapping with the line RL21, and the other one of the second-direction guidelines GL2 is displayed overlapping with the line RL22. In addition, FIG. 4 illustrates an aspect in which one of the first-direction guidelines GL1 is displayed on the inner side of the line RL10 and the other one of the first-direction guidelines GL1 is displayed on the inner side of the line RL11.

One of the first-direction guidelines GL1 may be displayed overlapping with the line RL10, and the other one of the first-direction guidelines GL1 may be displayed overlapping with the line RL11. One of the second-direction guidelines GL2 may be displayed on the inner side of the line RL21, and the other one of the second-direction guidelines GL2 may be displayed on the inner side of the line RL22.

The controller 111 may be configured to cause the display 113 to display the guidelines GL using a color different from the color of the lines RL. For example, the lines RL may be displayed in gray color, and the guidelines GL may be displayed in pink color. The first-direction guidelines GL1 may be displayed in a color different from the second-direction guidelines GL2. The guidelines GL may be displayed in the same color as the lines RL.

Before the above-described guidelines GL are displayed by the display 113, a platen size selection screen SF2 is displayed by the display 113 as illustrated in FIG. 5. The user can select a desired platen size from a plurality of platen sizes displayed on the selection screen SF2 by operating a button CB10. When a roll film is used as the transfer film F, the user can select “Roll Paper” as the platen size. The guidelines GL on the display 113 may be displayed at the same time as the display of the selection screen SF2. In this case, the guidelines GL may be displayed, for example, by a pop-up screen.

After the user selects the platen size as described above, the controller 111 causes the display 113 to display a setting screen SF3 of the guidelines GL in a setting step. Thus, as illustrated in FIG. 6, the setting screen SF3 of the guidelines GL is displayed by the display 113. The user can set the guidelines GL to be displayed by the display 113 on the setting screen SF3.

A screen for designating at least one of a first distance K1, a second distance K2, a third distance K3, and a fourth distance K4 is displayed by the display 113 as the setting screen SF3. FIG. 6 illustrates an aspect in which a setting screen SF3 for designating all of the first distance K1, the second distance K2, the third distance K3, and the fourth distance K4 is displayed. However, the setting screen SF3 may be a screen for designating three or less distances among the first distance K1, the second distance K2, the third distance K3, and the fourth distance K4.

The first distance K1 is the distance from the first end E1 of the platen 11 to the inner position of the platen 11. The second distance K2 is the distance from the second end E2 of the platen 11 to the inner position of the platen 11. The third distance K3 is the distance from the third end E3 of the platen 11 to the inner position of the platen 11. The fourth distance K4 is the distance from the fourth end E4 of the platen 11 to the inner position of the platen 11. The inner position of the platen 11 is a position including positions on the outer edge of the platen 11, which is the ends E1 to E4, and is any position on the inner side of the platen 11.

As illustrated in FIG. 6, an input box CB1 for designating the first distance K1, an input box CB2 for designating the second distance K2, an input box CB3 for designating the third distance K3, and an input box CB4 for designating the fourth distance K4 are displayed on the setting screen SF3. The unit of the distances K1 to K4 is, for example, mm or inch. The user can input desired values in the input boxes CB1 to CB4. FIG. 6 illustrates an aspect in which the first distance K1 and the second distance K2 are 0.00 mm, and the third distance K3 and the fourth distance K4 are 0.20 mm.

The user can select to display or hide the guidelines GL by operating a button CB5 displayed on the setting screen SF3. After inputting the distances K1 to K4, the user can complete the setting of the distances K1 to K4 by operating a button CB6 displayed on the setting screen SF3. The user can cancel the input distances K1 to K4 by operating a button CB7 displayed on the setting screen SF3.

After the user operates the button CB6, the controller 111 causes the display 113 to display the guidelines GL in at least one of the following inner positions of the platen 11: a position away from the first end E1 of the platen 11 by a first distance K1; a position away from the second end E2 by a second distance K2; a position away from the third end E3 by a third distance K3; or a position away from the fourth end E4 by a fourth distance K4. FIG. 4 illustrates an aspect in which one of the second-direction guidelines GL2 is displayed on the line RL21 corresponding to the first end E1 of the platen 11, and the other one of the second-direction guidelines GL2 is displayed on the line RL22 corresponding to the second end E2 of the platen 11. At least one of the input boxes CB1 to CB4 may be displayed on the setting screen SF3, and the guidelines GL may be displayed at a distance designated with the displayed input box. FIG. 4 also illustrates an aspect in which the one of the first-direction guidelines GL1 is displayed at a position away inward from the line RL10 corresponding to the third end E3 of the platen 11 by 0.20 mm as the third distance K3, and the other one of the first-direction guidelines GL1 is displayed at a position away inward from the line RL11 corresponding to the fourth end E4 of the platen 11 by 0.20 mm as the fourth distance K4.

Here, as illustrated in FIG. 3, in the platen 11, the region up to the position away from the first end E1 by the first distance K1, the region up to the position away from the second end E2 by the second distance K2, the region up to the position away from the third end E3 by the third distance K3, and the region up to the position away from the fourth end E4 by the fourth distance K4 are taken as, for example, the region HR not printed on the transfer film F. That is, the region HR is, for example, a region where no ink droplets are ejected from the ejection heads 20. In addition, the region HR is the above-described region where the transfer film F is pressed by the pressing member 49. The user can input the distances K1 to K4 in consideration of the dimension and the like of the pressing member 49. This allows the user to easily recognize the printable region IR, based on the guidelines GL displayed based on the distances K1 to K4. In FIG. 3, the dimension of the region up to the position away from the third end E3 by the third distance K3 is larger than the dimension of the one pressing member 49 in the second direction Dx, and the dimension of the region up to the position away from the fourth end E4 by the fourth distance K4 is larger than the dimension of the other pressing member 49 in the second direction Dx.

As described above, after the user selects the platen size, the following aspects may be adopted instead of displaying the guidelines GL based on the distances K1 to K4 designated by the user on the setting screen SF3. The controller 111 may be configured to acquire the information on the platen size by the user selecting the platen size, and to cause the display 113 to perform the display with the positions of the guidelines GL being changed according to the acquired platen size in the display step. In this case, the platen size and the positions of the guidelines GL corresponding to the platen size are set in advance. That is, the platen size and the distances K1 to K4 corresponding to the platen size are set in advance. Then, after the user selects the platen size on the platen size selection screen SF2, the controller 111 causes the display 113 to display the guidelines GL based on the distances K1 to K4 corresponding to the platen size selected by the user. Alternatively, the controller 111 may acquire the information on the size of the pressing member 49, and cause the display 113 to perform the display with the positions of the guidelines GL being changed according to the acquired size of the pressing member 49 in the display step. In this case, the size of the pressing member 49 (that is, the dimension in the second direction Dx of the pressing member 49) and the positions of the guidelines GL corresponding to the size (that is, the first-direction guidelines GL1) are set in advance. After the size of the pressing member 49 is selected by the user, the controller 111 causes the display 113 to display the guidelines GL based on the size selected by the user.

As described above, according to the present embodiment, since the lines RL indicating the platen region PR are displayed, the user can easily recognize the platen region PR. In addition, the guidelines GL can be displayed at least on the inner side of the platen region PR. Thereby, the region between the guidelines GL and the lines RL10, RL11, RL21, and RL22 indicating the outline of the platen region PR among the lines RL (for example, the region in which the pressing member 49 for pressing the transfer film F toward the platen 11 when ejecting ink droplets is provided) is clear to the user. Therefore, the user can layout the image to be printed under the guide of the guidelines GL while avoiding ink droplets from being ejected onto the region. In addition, since the user can set the display of the guidelines GL independently of the lines RL, the positions of the guidelines GL can be set to desired positions according to the image to be printed.

In the present embodiment, the first-direction guidelines GL1 and the second-direction guidelines GL2 are displayed in the platen region PR indicated by the lines RL as the guidelines GL. Accordingly, the user can easily recognize the printable region IR based on the guidelines GL1 and GL2.

In the present embodiment, the controller 111 may cause the display 113 to display the guidelines GL based on the distances K1 to K4 corresponding to the platen size selected by the user. In this case, the position of the guidelines GL is changed according to the platen size, so that the user can recognize the printable region IR according to the platen size.

In the present embodiment, the controller 111 may cause the display 113 to display the guidelines GL using a color different from the color of the lines RL. Accordingly, the user can easily distinguish the positions of the guidelines GL from the positions of the lines RL.

In the present embodiment, a screen for designating at least one of the first distance K1, the second distance K2, the third distance K3, or the fourth distance K4 is displayed by the display 113 as the setting screen SF3. Then, the controller 111 causes the display 113 to display the guidelines GL in at least one of a position away from the first end E1 of the platen 11 by the first distance K1, a position away from the second end E2 by the second distance K2, a position away from the third end E3 by the third distance K3, or a position away from the fourth end E4 by the fourth distance K4. Accordingly, the user can freely display the guidelines GL at any position separated by the designated distance.

In the present embodiment, in the platen 11, the region up to the position away from the first end E1 by the first distance K1, the region up to the position away from the second end E2 by the second distance K2, the region up to the position away from the third end E3 by the third distance K3, and the region up to the position away from the fourth end E4 by the fourth distance K4 are the region HR not printed on the transfer film F. In this case, it is possible to prevent ink droplets from being ejected onto a region that is not preferable to be printed on the transfer film F.

In the present embodiment, the region HR not printed on the transfer film F is a region where the transfer film F is pressed by the pressing member 49. Accordingly, it is possible to prevent ink droplets from being ejected onto the region where the transfer film F is pressed by the pressing member 49.

In the present embodiment, the controller 111 may cause the display 113 to display the guidelines GL based on the size of the pressing member 49. In this case, the positions of the guidelines GL change if a pressing member 49 of a different size is used. Therefore, the printable region IR can be displayed in an enlarged manner if a pressing member 49 smaller than the current pressing member 49 is used. Accordingly, the layout width of the print image is widened by the user. Alternatively, the printable region IR may be displayed in a reduced if a pressing member 49 larger than the current pressing member 49 is used. Accordingly, it is possible to prevent ink droplets from being ejected onto the region where the transfer film F is pressed by the pressing member 49.

Further, in the present embodiment, the information on the guidelines GL is not included in the image data. This makes it possible to use the guidelines GL to be displayed only at the time of layout of the print image, thereby avoiding an increase in the volume of image data.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The above embodiment has described that the guidelines GL are displayed by the display 113 based on the selected platen size after the user selects the platen size on the platen size selection screen SF2. In this case, the selection screen SF2 corresponds to the setting screen of the guidelines displayed in the setting step.

In the above embodiment, the region HR is a region not printed on the transfer film F, that is, a region where no ink droplets are ejected from the ejection heads 20, but is not limited thereto. The user may use the region HR as a region for performing layout in which images are arranged. Accordingly, the width of the design of the image increases.

In the above-described embodiment, the ejection heads 20 may include one or a plurality of ejection heads for ejecting ink droplets of a base color such as white ink.

Further, in the above embodiment, the screens SF1, SF2, and SF3 are displayed by the display 113 of the image data generation device 101, but are not limited to this. The screens SF1, SF2, and SF3 may be displayed by a display of a personal computer or the like capable of communicating with the image data generation device 101 via wired or wireless communication.

What is claimed is:

1. A non-transitory computer readable storage medium storing a guideline display program configured to be executed by a computer in an image data generation device, the image data generation device including the computer and a display,
the computer being configured to generate image data on an image, the image being formed by ejecting ink from an ejection head provided in a printing device onto a printed medium placed on a platen provided in the printing device,
the display being configured to display the image data,
the guideline display program comprising instructions which, when executed by the computer, cause the computer to execute:
a setting step of causing the display to display a setting screen of a guideline indicating a printable region, the guideline being allowed to have a display setting independent of a line indicating a platen region that is a region of the platen; and
a display step of causing the display to display the line and of causing the display to display the guideline on at least an inner side of the platen region, the guideline being set on the setting screen.

2. The non-transitory computer readable storage medium according to claim 1,
wherein, in the display step, any one of a first-direction guideline along a first direction in the platen region indicated by the line, a second-direction guideline along a second direction orthogonal to the first direction in the platen region, or the first-direction guideline and the second-direction guideline is displayed as the guideline, the first direction in which a conveying unit provided in the printing device is configured to convey the printed medium.

3. The non-transitory computer readable storage medium according to claim 1, further causing the computer to execute an acquisition step of acquiring a size of the platen,
wherein in the display step, a position of the guideline displayed on the display is changed according to the acquired size of the platen.

4. The non-transitory computer readable storage medium according to claim 1,
wherein in the display step, the guideline is displayed using a color different from a color of the line.

5. The non-transitory computer readable storage medium according to claim 1,
wherein the platen includes:
a first end located on one side in a first direction in which a conveying unit provided in the printing device is configured to convey the printed medium;
a second end located on an other side in the first direction;
a third end located on one side in a second direction orthogonal to the first direction; and
a fourth end located on an other side in the second direction,
in the setting step, a screen is displayed for designating at least one of a first distance from the first end to an inner position of the platen, a second distance from the second end to the inner position of the platen, a third distance from the third end to the inner position of the platen, and a fourth distance from the fourth end to the inner position of the platen, and
in the display step, the guideline is displayed in at least one of a position away from the first end by the first distance, a position away from the second end by the second distance, a position away from the third end by the third distance, or a position away from the fourth end by the fourth distance.

6. The non-transitory computer readable storage medium according to claim 5,
wherein, among a region of the inner position of the platen, a region up to the inner position that is the position away from the first end by the first distance, a region up to the inner position that is the position away from the second end by the second distance, a region up to the inner position that is the position away from the third end by the third distance, and a region up to the inner position that is the position away from the fourth end by the fourth distance, are a region not printed on the printed medium.

7. The non-transitory computer readable storage medium according to claim 6,
wherein
the region not printed on the printed medium is a region in which the printed medium is pressed by a pressing member included in the printing device and configured to press the printed medium toward the platen in a case where the ejection head ejects ink.

8. The non-transitory computer readable storage medium according to claim 7, further causing the computer to execute an acquisition step of acquiring a size of the pressing member,
wherein in the display step, a position of the guideline displayed on the display is changed according to the acquired size of the pressing member.

9. The non-transitory computer readable storage medium according to claim 1,
wherein the information on the guideline is not included in the image data.

10. A guideline display method for an image data generation device configured to create image data on an image to be printed on a printed medium placed on a platen, the guideline display method comprising:
displaying a setting screen of a guideline indicating a printable region, the guideline being allowed to have a display setting independent of a line indicating a platen region that is a region of the platen; and
displaying the line and displaying the guideline on at least an inner side of the platen region, the guideline being set on the setting screen.
